(19) United States
(12) Patent Application Publication
(10) Pub. No.: US 2025/0179794 A1
(43) Pub. Date: Jun. 5, 2025

(54) ARTIFICIAL ROCKWORK SYSTEMS AND METHODS

(71) Applicant: Universal City Studios LLC, Universal City, CA (US)

(72) Inventors: Estevan Padilla, Orlando, FL (US); John Clifton Hawkins, II, Orlando, FL (US)

(21) Appl. No.: 18/967,396

(22) Filed: Dec. 3, 2024

Related U.S. Application Data
(60) Provisional application No. 63/606,259, filed on Dec. 5, 2023.

(51) Int. Cl. E04C 2/04; B33Y 80/00; B44C 5/06; E04C 2/00

(52) U.S. Cl. CPC E04C 2/04; B44C 5/06; B33Y 80/00; E04C 2002/008

(57) ABSTRACT

In an embodiment an artificial rockwork system is provided that includes a support structure, and a plurality of artificial rockwork panels. The artificial rockwork system includes a plurality of artificial rockwork panels. An individual artificial rockwork panel of the plurality of artificial rockwork panels includes a first layer, one or more reinforcement structures, a second layer, a mesh layer, and an exterior layer. The one or more reinforcement structures include one or more couplings are positioned on a first end of the one or more reinforcement. The second layer is disposed over at least a portion of the second surface of the first layer to secure the one or more reinforcement structures within the individual artificial rockwork panel.

### CROSS-REFERENCE TO RELATED APPLICATION

This application claims priority from and the benefit of U.S. Provisional Application Ser. No. 63/606,259, entitled “ARTIFICIAL ROCKWORK SYSTEMS AND METHODS”, filed Dec. 5, 2023, which is hereby incorporated by reference in its entirety.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

The subject matter disclosed herein relates to the construction of rockwork features, and more specifically, to an improved rockwork system for themed environments.

Themed environments may include various entertainment attractions useful in providing enjoyment to guests of the themed environments. For example, the attractions may include a ride attraction (e.g., closed-loop track, dark ride, thrill ride, or other similar ride), and the attraction may be part of a themed environment that may be traditionally established using equipment, furniture, building layouts, props, decorations, displayed media, and so forth. Structures in these environments may be constructed using conventional building techniques, and components of the structures may be custom-built for the themed environment. However, forming these custom-built components is complex and time-consuming.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment an artificial rockwork system is provided that includes a primary support structure, a secondary support structure, and a plurality of artificial rockwork panels. The primary support structure is a portion of a support structure of a themed environment. The secondary support structure is positioned along a horizontal axis of the primary support structure. An individual artificial rockwork panel of the plurality of artificial rockwork panels includes a first layer, one or more reinforcement structures, a second layer, a mesh layer, and an exterior layer. The one or more reinforcement structures include one or more couplings positioned on a first end of the one or more reinforcement structures. The one or more couplings are configured to couple to the secondary support structure. The second layer is disposed over at least a portion of the second surface of the first layer to secure the one or more reinforcement structures within the individual artificial rockwork panel. The mesh layer overhangs one or more edges of the second layer and embeds at least a portion of the mesh layer within the individual artificial rockwork panel.

In an embodiment, an additive construction method for manufacturing an artificial rockwork panel is provided. The method includes forming a first layer of build material and disposing one or more reinforcement structures partially within the first layer such that one or more couplings are positioned on a first end of the one or more reinforcement structures. The method also includes forming a second layer of build material over a portion of the one or more reinforcement structures and over the second surface of the first layer to secure the portion of the one or more reinforcement structures between the first layer and the second layer. Further, the method includes positioning a mesh layer on the second layer, wherein the mesh layer is configured to overhang at least one edge of the second layer and forming an exterior layer to secure a nonoverhanging portion of the mesh layer between the second layer and the exterior layer.

In an embodiment, an individual artificial rockwork panel of the plurality of artificial rockwork panels is provided. The individual artificial rockwork panel includes a first layer and one or more reinforcement structures disposed partially within the first layer and comprising one or more couplings are positioned on a first end of the one or more reinforcement structures, wherein the one or more couplings are configured to couple to the secondary support structure. The individual artificial rockwork panel also includes a second layer disposed over at least a portion of the second surface of the first layer to secure the one or more reinforcement structures within the individual artificial rockwork panel. Further, the individual artificial rockwork panel includes a mesh layer, wherein the mesh layer overhangs one or more edges of the second layer and an exterior layer disposed over the mesh layer to embed at least a portion of the mesh layer within the individual artificial rockwork panel.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an amusement park attraction including an artificial rockwork system, in accordance with embodiments described herein;

FIG. 2 is an orthogonal view of components of an artificial rockwork system, in accordance with embodiments described herein;

FIG. 3 is a schematic illustration of an individual artificial rockwork panel of the artificial rockwork system, in accordance with embodiments described herein;

FIG. 4 is an exploded view of an individual artificial rockwork panel, in accordance with embodiments described herein;

FIG. 5 is a sectional view of an artificial rockwork panel coupled to a support system of the artificial rockwork system, in accordance with embodiments described herein;

FIG. 6 is a schematic illustration of coupled artificial rockwork panels of the artificial rockwork system, in accordance with embodiments described herein;

FIG. 7 is a portion of the artificial rockwork system of FIG. 6, in accordance with embodiments described herein;

FIG. 8 is a schematic illustration of formation of an artificial rockwork panel of the artificial rockwork system of FIG. 1, including a dynamic molding bed, in accordance with embodiments described herein; and

FIG. 9 is a flow diagram of a method of forming an artificial rockwork panel, in accordance with embodiments described herein.

### DETAILED DESCRIPTION

One or more specific embodiments will be described below. In an effort to provide a concise description of these embodiments, not all features of an actual implementation are described in the specification. It should be appreciated that, in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A themed environment may enhance a guest experience by providing themed experiences, shows, and/or attractions. These themed environments may be established, at least in part, using themed structures situated in or around the themed environment, amusement rides, walkable areas, and the like, and may be positioned within view of the guest. Additionally, themed structures may be constructed for attractions of the themed environment, such as amusement rides, elevated walkable areas, viewing platforms, and the like to provide immersive guest experiences. For example, a themed structure may provide physical components of a themed environment. In certain cases, themed structures may provide fantastical narrative elements (e.g., volcanos, dinosaurs, alien environments) that involve irregular shapes and/or surfaces that cannot easily be formed with planar or right-angle configurations or conventional building materials.

Themed structures of the themed environment may involve multiple pieces that are manufactured separately prior to assembly at the themed environment. Further, because themed structures may have different shapes, forms, and sizes than those of conventional structures (e.g. conventional residential, commercial, or industrial structures), custom design and/or construction may be employed. However, custom design and construction may be expensive and time-consuming. Techniques for constructing custom-designed themed structures that allow for modularity and flexibility to establish a themed environment are desired. In some cases, artificial rockwork panels with a level of detail replicating natural environmental structures or themed building components involve extensive customization that is established from the early stages of panel design. Such extensive customization of the artificial rockwork panels is cumbersome, may limit production speed, increases weight and thickness of the artificial rockwork panels (e.g., increasing assembly time), and may limit scalability. There is a need for scalable, at least partially modular, and less burdensome customization of the artificial rockwork panels.

The disclosed embodiments provide systems and methods that may be used to provide artificial rockwork panels for inclusion in themed environments. In certain cases, the artificial rockwork panels may be formed using additive construction (e.g., additive manufacturing, additive manufacturing with inclusion of machined elements) and assembled on external support structures via couplings. The artificial rockwork panels, formed through additive construction, may include multiple build layers. The build layers of the artificial rockwork panels may be capable of being formed in part or in whole off-site (e.g., off-site from the themed environment) to reduce onsite fabrication costs and/or expedite onsite construction.

Additionally, the present disclosure relates to systems and methods for formation and assembly of the artificial rockwork system. The artificial rockwork panels may be formed through additive construction to generate multiple build layers to provide modular and customizable artificial rockwork panels. In some embodiments, at least a first layer of build material is formed using additive construction. Additive construction may include additive manufacturing, 3D printing, and/or concrete printing. One or more reinforcement structures may be inserted into the first layer to provide structural support and/or couplings for use in assembly of the artificial rockwork system. One or more additional layers of build material may be formed to embed the border bars within the artificial rockwork panel. Further, a mesh layer is inserted that overhangs (e.g., in relation to the first and second layers) and provides attachment points for adjacent artificial rockwork panels. A themed carved layer is formed, e.g., atop the mesh layer, to form an external surface visible in the themed environment after assembly of the artificial rockwork system. Once formed, the artificial rockwork panels can be coupled to external supports and/or to each other using embedded or integral panel components.

In some embodiments, a dynamic molding bed including movable pins may be used to support the formation of the artificial rockwork panels. The dynamic molding bed allows for the formation of a non-planar configuration of the first layer of build material through dynamic control of a surface topography of the dynamic molding bed. A level of detail of the first layer of build material can be provided based on a resolution of the multiple pins generating the topographical surface of the dynamic molding bed. For example, a non-planar artificial rockwork panel may be formed using the topographical surface of the dynamic molding bed. Formation of the non-planar artificial rockwork panel may reduce weight and/or thickness (e.g., compared to planar artificial rockwork panels).

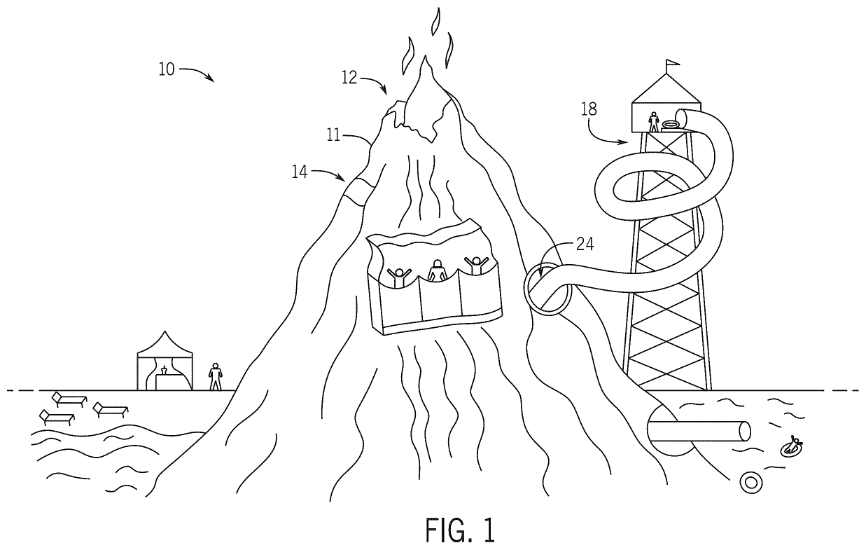

FIG. 1 is a schematic illustration of an embodiment of a themed environment 10 (e.g., an amusement park) including a structure 11 formed at least in part using an artificial rockwork system 12. In the illustrated embodiment, the artificial rockwork system 12 contributes to the themed environment by representing the themed landscape structure 11, illustrated here as representing exteriors of a rocky volcano. The artificial rockwork system 12 includes one or more individual artificial rockwork panels 14. The artificial rockwork system 12 provides aesthetic benefits and may, in embodiments, provide structural support for various features of the environment 10. For example, the artificial rockwork system may provide structural support for a portion 24 of the amusement ride 18. It should be understood that the illustrated themed environment 10 is an example of an environment for use in conjunction with the artificial rockwork system 12, and other applications are also contemplated.

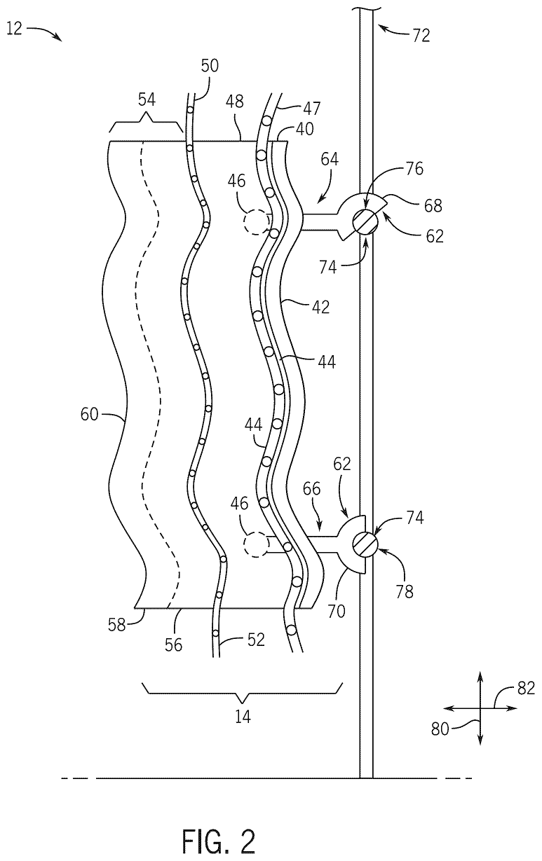

FIG. 2 illustrates an orthogonal view of the artificial rockwork system 12 including the individual artificial rockwork panel 14 and supporting structures. As illustrated, the artificial rockwork panel 14 may be formed from additive layers, such as a first layer 40, a second layer 48, etc. It should be understood that more or fewer layers than illustrated are contemplated. In a certain embodiment, one or more additive layers may be deposited directly on a preceding layer. Additionally or alternatively, certain layers may be separated by intervening structures and/or may have embedded structures that may be secured when a successive layer is overlaid.

The illustrated artificial rockwork panel 14 may include a first layer 40 having a first surface 42 and a second surface 44 opposing the first surface 42. The individual artificial rockwork panel 14 also includes reinforcement structures 46 (e.g., one or more reinforcement structures). The individual artificial rockwork panel 14 may include a mesh layer 47 positioned between the first layer 40 and the reinforcement structures 46. The artificial rockwork panel 14 may include a second layer 48. Further, the individual artificial rockwork panel 14 may include a mesh layer 50 that overhangs with respect to the second layer 48. A mesh overhang 52 overhangs (e.g., protrudes) from the individual artificial rockwork panel 14 on one or more sides. The individual artificial rockwork panel 14 also may include an exterior layer 54. In some embodiments, the exterior layer 54 includes a first portion 56 and a second portion 58. The exterior layer 54 may include a themed or shaped surface 60 (e.g., surface with artificial rock elements) formed to be viewed by the guests 22 of the themed environment 10. It should be understood that the artificial rockwork panels 14 disclosed herein may be shaped or finished in a manner appropriate for the themed environment. Thus, while artificial rockwork panels 14 may simulate masonry or rock structures, it should be understood that the disclosed rockwork panels 14 and artificial rockwork system 12 may be used to form other types of structures, such as themed characters or natural or alien environments.

In some embodiments, the individual artificial rockwork panel 14 includes one or more reinforcement structures 46 disposed partially within the first layer 40. The reinforcement structures 46 may include couplings 62 (e.g., one or more couplings) on a first end of the reinforcement structures 46. The first end of the reinforcement structures 46 on the side of the surface 42 of the first layer 40. A second end of the reinforcement structures 46 may be positioned within the second layer 48. The couplings 62 positioned on the first end of the reinforcement structures 46 may be used to secure the individual artificial rockwork panel 14 on support structures (e.g., an external support structure). In some embodiments, the reinforcement structures 46 may be disposed on the mesh layer 47. The mesh layer 47 may be used to integrate the reinforcement structures 46 into the individual rockwork panel 14. Additionally and/or alternatively, the second layer 48 may be disposed over at least a portion of the second surface 44 of the first layer 40 to secure (e.g., embed) the reinforcement structures 46 within the individual artificial rockwork panel 14. In some instances, the mesh layer 50 may be positioned on the second layer 48. The mesh layer 50 overhangs one or more edges of the second layer 48. The exterior layer 54 may be disposed over the mesh layer 50 to embed at least a portion (e.g., nonoverhanging portion) of the mesh layer 50 within the individual artificial rockwork panel 14. Further, the individual artificial rockwork panel 14, once formed, may be secured to support structures (e.g., external support structures).

The couplings 62 of the reinforcement structures 46 may be positioned relative to the first surface 42 at predefined locations corresponding to one or more coupling locations. This may be accomplished during formation of the first layer 40 such that passages corresponding to the coupling locations may be formed in the first layer 40 to permit the reinforcement structure 46 to be positioned on (or in a pre-formed recess of) the first layer 40 such that a portion of the reinforcement structure 46 protrudes through the first layer 40. The couplings 62 may be positioned at the one or more coupling locations including a first predefined location 64 and a second predefined location 66. The couplings 62 may include a hook 68 and/or a clip 70 to secure the individual artificial rockwork panel 14 to a primary support structure 72. That is, the first end including the couplings 62 may form a contiguous connection between the individual artificial rockwork panel 14 and the primary support structure 72. In some embodiments, the hook 68 may be disposed at the first predefined location 64 and the clip 70 is disposed at the second predefined location 66. In some embodiments, the hook 68 may be disposed at the second predefined location 66 and the clip 70 is disposed at the first predefined location 64. In some instances, the hook 68 may be disposed at both the first predefined location 64 and the second predefined location 66. In yet other embodiments, the clip 70 may be disposed at both the first predefined location 64 and the second predefined location 66. It should be noted, that any suitable fastener (e.g., clamps, clips, pins, bolts, screws, anchors, etc.) may be used as the coupling 62 to attach the individual artificial rockwork panel 14 to the primary support structure 72.

In certain embodiments, multiple individual artificial rockwork panels 14 may be mounted to support structures to form the themed landscape (e.g., volcano, dinosaur, mountain, etc.) of the themed environment (e.g., the amusement park). The themed landscape may include the primary support structure 72 and a secondary support structure 74. The primary support structure 72 may be a portion of a support structure of the themed environment. The primary support structure 72 may be coupled to a secondary support structure 74. The secondary support structure 74 may include one or more hanging rails including a first hanging rail 76 and a second hanging rail 78 used to mount the individual artificial rockwork panel 14. To aid the discussion, a set of axes will be referenced. For example, a longitudinal axis 80 may run from top to bottom of the primary support structure 72, and a latitudinal axis 82 may run along the secondary support structure 74. The individual artificial rockwork panel 14 may be coupled to the secondary support structure 74 by way of the reinforcement structures 46. The individual artificial rockwork panel 14 may be fixed in position vertically (e.g., along the longitudinal axis) and horizontally (e.g., along the latitudinal axis) to the secondary support structure 74. In an embodiment, the hook 68 disposed at the first predefined location 64 may be coupled to the first hanging rail 76 of the secondary support structure 74 and the clip 70 disposed at the second predefined location 66 may be coupled to the second hanging rail 78 of the secondary support structure 74. The individual artificial rockwork panel 14 may be secured to the primary support structure 72. In some instances, multiple individual artificial rockwork panels 14 may be formed offsite of the themed environment and assembled (e.g., coupled to support structures) after formation of multiple individual artificial rockwork panels 14 to streamline construction of the themed landscape.

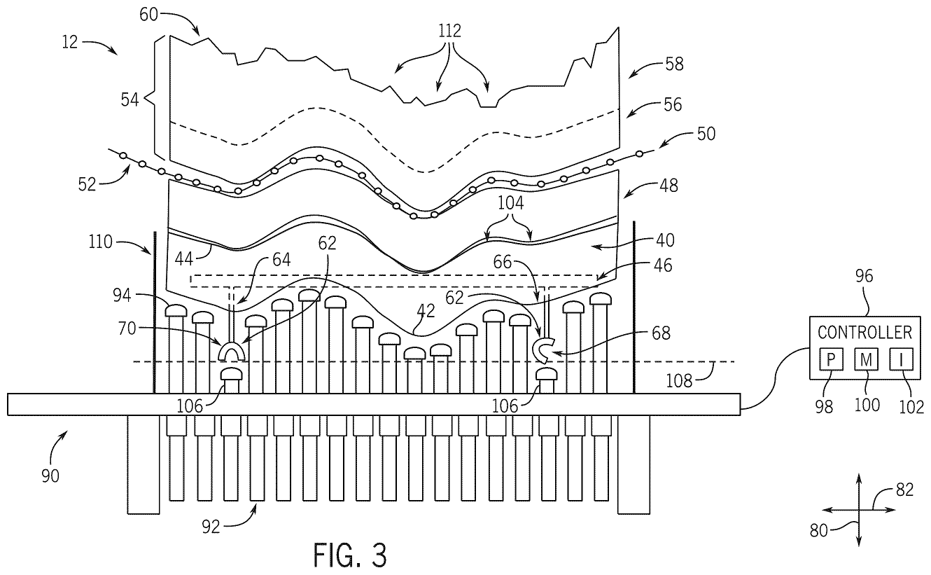

With the foregoing in mind, FIG. 3 is a schematic illustration of an embodiment of the artificial rockwork system 12 including the individual artificial rockwork panel 14 and a dynamic molding bed 90. The dynamic molding bed 90 may include multiple pins 92 (e.g., a plurality of pins) that support the formation of the individual artificial rockwork panel 14. The dynamic molding bed 90 allows for the formation of the first layer 40 of build material through dynamic control of the pins 92 to form a molding surface 94 to support a non-planar configuration of the first surface 42 of the first layer 40 of build material. In some embodiments, the dynamic molding bed 90 may be controlled by a controller 96 that includes a processor 98, a memory 100 and instructions 102. The controller 96 may directly control actuation of the pins 92 or be controlled externally by systems externally connected to the controller 96. For example, the pins 92 of the dynamic molding bed 90 may be actuated by a robotic arm or any suitable passive or active component to generate the molding surface 94. To aid the discussion, a set of axes will be referenced. For example, a longitudinal axis 80 may run from top to bottom of the individual artificial rockwork panel 14, and a latitudinal axis 82 may run along the dynamic molding bed 90.

In some embodiments, the controller 96 may control the dynamic molding bed 90 to form the molding surface 94 based on the instructions 102 (e.g., building parameters, digital maps of the non-planar configuration, model of topographical features) that may be stored in the memory 100 and executed by the processor 98 of the controller 96. Moreover, the memory 100 may include a volatile memory, such as random-access memory (RAM), and/or nonvolatile memory, such as read-only memory (ROM). The memory 100 may store a variety of information and may be used for various purposes. For example, the memory 100 may store processor-executable instructions (e.g., hardware, software) for the processor 98 to execute, including the instructions 102 for controlling various components of the dynamic molding bed 90. The instructions 102 may control the actuation of the plurality of pins 92 to take on the molding surface 94 desired for formation of the first surface 42 of the first layer 40 of build material of the individual artificial rockwork panel 14. The processor 98, which may be one or more processors, and/or more generally a processing circuitry, may include any suitable processor or microprocessor capable of executing processor executable code. Moreover, the processor 98 may include multiple microprocessors, one or more “general-purpose” microprocessors, one or more special-purpose microprocessors, and/or one or more application specific integrated circuits (ASICS), or some combination thereof. For example, the processor 98 may include one or more than one reduced instruction set (RISC) or complex instruction set (CISC) processors. The memory 100 and/or the processor 98, or any additional memory and/or processor, may be located in any suitable portion of the dynamic molding bed 90.

In some embodiments, the individual artificial rockwork panel 14 is formed in whole or in part on the dynamic molding bed 90. The first layer 40 of build material may be disposed on the dynamic molding bed 90 and takes on a configuration (e.g., a planar configuration, the non-planar configuration) of the plurality of pins 92. For example, the pins 92 support the first layer 40 of build material and generate topographical features (e.g., rock like conformations) on the first surface 42 in the non-planar configuration generating a level of detail 104 of the first layer 40. The level of detail 104 of the first layer 40 may be based on a resolution of the multiple pins generating the molding surface 94 of the dynamic molding bed 90. The resolution may be determined based on a pin to pin distance (e.g., longitudinal distance between pins) and a size of the pins 92. The level of detail 104 of the first layer 40 can be designed to generate the first surface 42 of the first layer 40 of build material conducive to final implementation parameters of the artificial rockwork system 12.

The reinforcement structures 46, which may include the couplings 62, may be disposed partially within the first layer 40. The couplings may be positioned at the first end of the reinforcement structures 46. The pins 92 of the dynamic molding bed 90 may be independently controlled by the controller 96 to actuate to a vertical position 106 permits the one or more reinforcement structures 46 to protrude from the first surface 42 of the first layer 40 to occupy a space within the dynamic molding bed 90. For example, the clip 70 disposed on the reinforcement structures 46 may be positioned within the space below the molding surface 94 of the dynamic molding bed 90 to allow formation of individual artificial rockwork panels 14 on the dynamic molding bed 90. In some embodiments, the individual artificial rockwork panel 14 may be removed from the dynamic molding bed 90 at any point during the formation process including before positioning the reinforcement structures 46.

In certain embodiments, the couplings 62 of the reinforcement structures 46 may be aligned at an imaginary plane 108. The first predefined location 64 and the second predefined location 66 of the couplings 62 may be positioned within the first layer 40 to provide alignment of the couplings 62 along the imaginary plane 108 to aid in coupling to the secondary support structure 74. For example, the couplings 62 of the reinforcement structures 46 may include the clip 70, the hook 68 or any combinations of fasteners positioned within the first layer 40 of build material to be aligned along the imaginary plane 108 to enhance modularity of the individual artificial rockwork panel 14 during assembly at the themed environment 10.

The second layer 48 may be formed on the second surface 44 of the first layer 40 to embed the reinforcement structures 46. The second layer 48 may be disposed over a portion of the reinforcement structures 46 and over the second surface 44 of the first layer 40 to secure the portion of the reinforcement structures 46 between the first layer 40 and the second layer 48. The second layer 48 takes on the level of detail 104 of the first layer 40, as shown in the illustrated embodiment. Further, the molding surface 94 of the dynamic molding bed 90 may define topographical features of the second layer 48. It should be noted, in some embodiments, one or more intervening layers (e.g., additional layers) may be formed between the first layer 40 and the second layer 48.

In some embodiments, the mesh layer 50 may be positioned on top of the second layer 48. The mesh layer 50 may conform to the level of detail 104 (e.g., the shape) of the first layer 40 as determined by the non-planar configuration of the molding surface 94 of the dynamic molding bed 90 as controlled by the pins 92. In certain embodiments, the mesh layer 50 overhangs one or more edges of the second layer 48 positioning the mesh overhang 52 beyond a mold dam 110 of the dynamic molding bed 90. The mold dam 110 of the dynamic molding bed 90 may be positioned to confine formation of build materials of various layers (e.g., first layer, second layer, exterior layer) used to form the individual artificial rockwork panel 14.

In certain embodiments, the exterior layer 54 may be formed to secure the nonoverhanging portion of the mesh layer 50 between the second layer 48 and the exterior layer 54. The first portion 56 of the exterior layer 54 may be formed to form to the non-planar configuration as defined by the molding surface 94 of the dynamic molding bed 90. Further, the second portion 58 of the exterior layer 54 may be formed to obtain a layer of detail 112 (e.g., more detail than the layer of detail 104 of the first layer 40) that resembles the rock surface 60 designed to be exposed to guests 22 within the themed environment 10. The second portion 58 of the exterior layer 54 may be formed using different build materials than the first portion 56 of the exterior layer 54.

With this in mind, build materials of the individual artificial rockwork panel 14 may include concrete, plastics, metals, composite materials, or any build material suitable for use in the artificial rockwork system 12. It may be advantageous for the first layer 40, the second layer 48, and one or more portions of the exterior layer 54 to be formed from a build material (e.g., concrete). For example, the build material may be extruded on the dynamic molding bed 90 using additive construction method (e.g., additive manufacturing, 3D printing, 3D concrete printing). In some instances, formation of the individual artificial rockwork panels 14 may include inclusion of machined elements such as the reinforcement structure 46. The reinforcement structures 46 may be formed from a different material (e.g., steel, metal, etc.) than the first layer 40, the second layer 48, and one or more portions of the exterior layer 54. In certain cases, the reinforcement structures 46 may be standardized and may be used in multiple individual artificial rockwork panels 14 of various sizes and/or non-planar configurations.

In some embodiments, the mesh layer 50 may provide connections for coupling one or more adjacent individual artificial rockwork panels to one another during assembly of the artificial rockwork system 12. For example, the mesh layer 50 may be a fiber mesh, wire mesh, metal mesh, or the like. In some instances, the mesh layer 50 may be non-directional (e.g., no specified orientation considerations). The mesh layer 50 may be formed or purchased prior to positioning within the individual artificial rockwork panels 14. Size and/or shape of the mesh layer 50 may be determined based on the size of the second layer 48 to ensure the mesh overhang 52 is positioned beyond one or more sides of the second layer 48. Further, the second layer may be a size (e.g., 8 feet by 4 feet, 4 feet by 4 feet, 4 feet by 2 feet) and/or a shape (e.g., rectangular, square, polygonal) as determined by a digital map of the artificial rockwork system 12. The mesh layer 50 may be a different size (e.g., 12 feet by 8 feet, 8 feet by 8 feet, 8 feet by 6 feet) and/or the shape of the second layer 48 or a different shape (e.g., rectangular, square, polygonal) allowing the mesh overhang 52 to be positioned beyond the second layer 48 to aid in coupling of the adjacent individual artificial rockwork panels.

In certain embodiments, a different material may be used to form the second portion 58 of the exterior layer 54. The different material may include clay, concrete, fiberglass, plastic, composite materials, and the like. The different material may be formed while the individual artificial rockwork panel 14 is located on the dynamic mold bed 90. In some instances, the different material may be formed by additive manufacturing at higher resolutions when compared to processes (e.g., additive construction) used to form the first layer 40, the second layer 48, and/or the first portion 56 of the exterior layer 54. In yet other embodiments, the second portion 58 of the exterior layer 54 may be formed after removal of the individual artificial rockwork panel 14 from the dynamic molding bed 90. The rock surface 60 of the individual artificial rockwork panel 14 may be formed off site (e.g., of the amusement park), on sire (e.g., of the amusement park) prior to or after assembly of the individual artificial rockwork panels 14. The rock surface 60 of the exterior layer 54 may provide realistic effects to the guest 22 at the themed environment 10 enhancing immersive experiences created by the themed landscape.

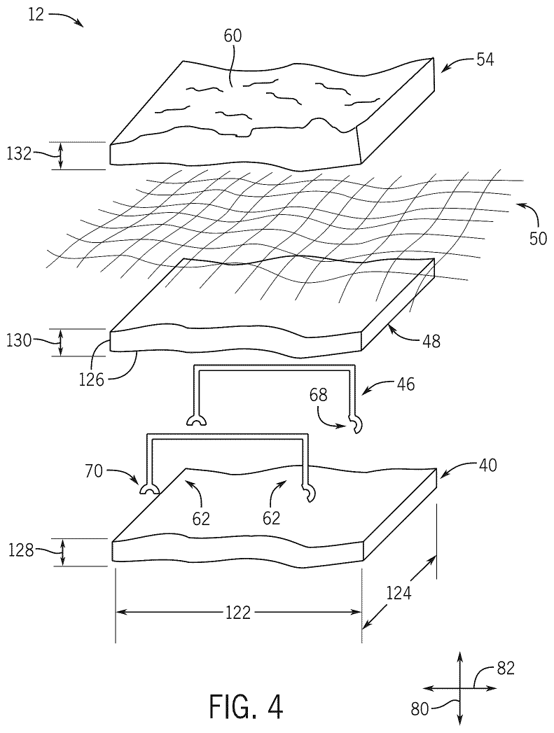

FIG. 4 is an exploded view of an embodiment of the individual artificial rockwork panel 14. The individual artificial rockwork panel 14 may include a first layer 40, multiple reinforcement structures 46, a second layer 48, a mesh layer 50 and the exterior layer 54 that may include the rock surface 60. To aid the discussion, a set of axes will be referenced. The first layer 40 may be formed using one or more predetermined side lengths 122, 124. In some embodiments, the side lengths 122, 124 are equal (e.g., square). In other embodiments, the side lengths 122, 124 are not equal (e.g., rectangular, polygonal). For example, the side length 122 may range from 2 feet to 12 feet, 2 feet to 8 feet, 4 feet to 12 feet, or the like. Additionally, the side length 124 may be 2 feet, and may range from 4 feet to 18 feet, 4 feet to 12 feet, 4 feet to 8 feet, or the like. The mesh layer 50 overhangs with respect to the second layer 48. The mesh layer 50 may overhang from the one or more edges 126 of the second layer 48. The mesh layer 50 may be a different size (e.g., 12 feet by 8 feet, 8 feet by 8 feet, 8 feet by 6 feet).

In certain embodiments, thickness levels of various layers of build material may be determined prior to formation by additive construction of the individual artificial rockwork panel 14. The first layer 40 may be formed using a first thickness level 128. The second layer 48 may be formed using a second thickness level 130. The exterior layer 54 may be formed using a third thickness level 132. For example, the first thickness level 128, the second thickness level 130, and the third thickness level 132 may be equal in thickness (e.g., 0.5 inch, 0.75 inch, 1 inches, 2 inches). In some instances, the third thickness level 132 may be greater (e.g., 0.75 inch, 1 inches, 2 inches, 3 inches, 4 inches) than the first thickness level 128 and/or the second thickness level 130.

In some embodiments, the predetermined side lengths 122, 124 and the thickness level of the individual artificial rockwork panel 14 may be determined by a digital map. The digital map may be an output of a software package that designs the artificial rockwork system 12. In other embodiments, the predetermined side lengths 122, 124 and the first thickness level 128, second thickness level 130, and/or third thickness level 132 may be determined by other outputs (e.g., blueprints, machine learning models, themed environment plans, architectural designs). Multiple individual artificial rockwork panels 14 may be formed for further assembly of the artificial rockwork system 12 to form the themed landscape. Further, the individual artificial rockwork panels may include an identification marker (e.g., QR code, RFID tag, alphanumeric system) to provide identity of individual artificial rockwork panel 14 to aid in assembly.

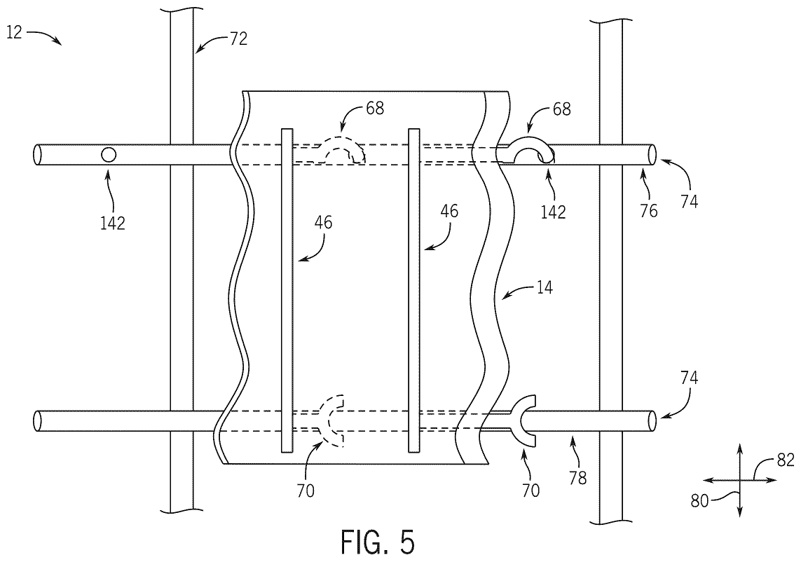

FIG. 5 is a sectional view of the artificial rockwork system 12 coupled to support structures. To aid the discussion, a set of axes will be referenced. For example, a longitudinal axis 80 may run from top to bottom of the primary support structure 72, and a latitudinal axis 82 may run along the secondary support structure 74. The individual artificial rockwork panel 14 may be coupled to the secondary support structure 74 affixed on the primary support structure 72. The primary support structure 72 and the secondary support structure 74 may include steel (e.g., carbon steel, stainless steel, mild steel, etc.) structures, trestle structures, fiberglass structures, concrete structures, and the like. In the illustrated embodiment, the couplings 62 disposed on the reinforcement structures 46 may include the hook 68 coupled to the first hanging rail 76 of the secondary support structure 74 by way of one or more passages 142. The passages 142 may be disposed along the first hanging rail 76 of the secondary support structure 74. The hook 68 may fit (e.g., slot in, drop in, etc.) into the passages 142 may be fixed in position vertically and horizontally (e.g., with respect to the longitudinal and latitudinal axes).

In certain embodiments, the couplings 62 disposed on the reinforcement structures 46 may include the clip 70 coupled to the second hanging rail 78 of the secondary support structure 74. For example, the clip 70 may partially couple around the second hanging rail 78 to fix in position the individual artificial rockwork panel 14 vertically and horizontally. In some instances, the couplings 62 used to couple the individual artificial rockwork panels 14 to support structures may be affixed to the support structures using alternative techniques including but not limited to mortar, fasteners, adhesive, dowels, or welding. The individual artificial rockwork panels 14 may be coupled to the support structures and may be coupled to adjacent individual artificial rockwork panels to form the themed landscape of the artificial rockwork system 12.

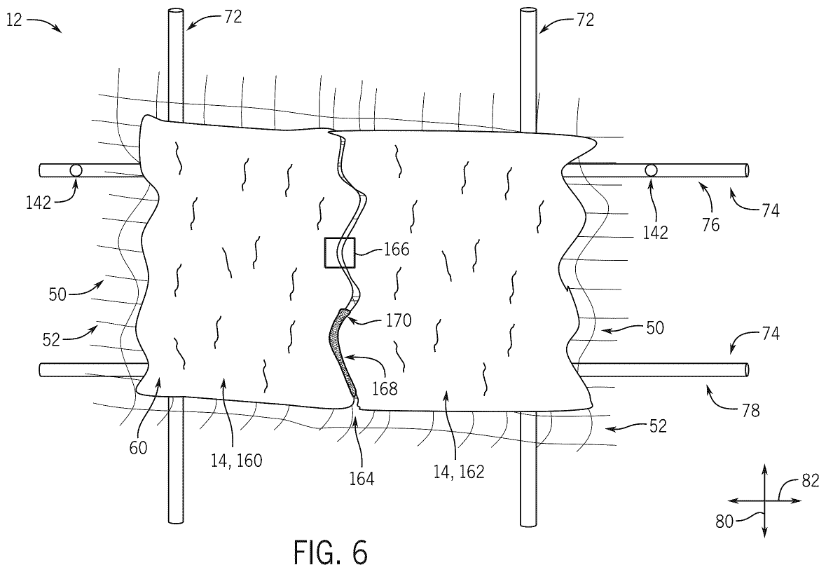

FIG. 6 is a schematic illustration of an example of the artificial rockwork system 12 including coupling adjacent rockwork panels (e.g., one or more adjacent rockwork panels). To aid the discussion, a set of axes will be referenced. For example, a longitudinal axis 80 may run from top to bottom of the primary support structure 72, and a latitudinal axis 82 may run along the secondary support structure 74. A first artificial rockwork panel 14, 160 (e.g., individual artificial rockwork panel of the plurality of artificial rockwork panels) may be coupled to a second artificial rockwork panel 14, 162 (e.g., positioned adjacent to the first artificial rockwork panel 14, 160). The first artificial rockwork panel 14, 160 and the second artificial rockwork panel 14, 162 may be positioned so that the mesh overhang 52 of the respective mesh layers of individual artificial rockwork panel 14 produce an overhanging portion 164 of the mesh layer 50. The respective overhanging portion 164 of the mesh layer 50 (e.g., respective overhanging mesh layers) may be used to form a mesh coupling 166 to couple the first artificial rockwork panel 14, 160 to the second artificial rockwork panel 14, 162. In some instances, the first artificial rockwork panel 14, 160 and the second artificial rockwork panel 14, 162 may be treated with a grout solution 168 to create a seam 170.

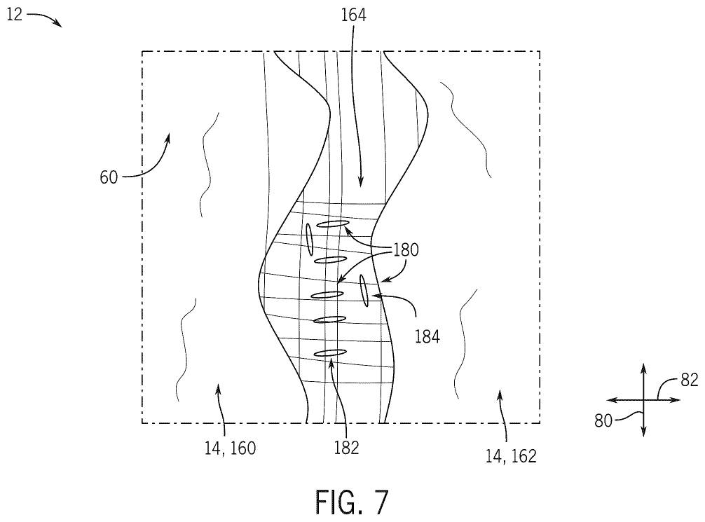

FIG. 7 is a schematic illustration of the mesh coupling 166 of FIG. 6. In some embodiments, the mesh coupling 166 is created using clips or other attachment elements (e.g., threaded connectors, clamps, fasteners). For example, the mesh coupling may be achieved using hog rings 180 that are used to couple the overhanging portions 164 of the mesh layer 50 of adjacent artificial rockwork panels 14. To aid the discussion, a set of axes will be referenced. For example, a longitudinal axis 80 may run from top to bottom of the individual artificial rockwork panel 14, and a latitudinal axis 82 may run along the individual artificial rockwork panel 14. In some embodiments, a horizontal hog ring 182 and/or a vertical hog ring 184 may be used to couple the first artificial rockwork panel 14, 160 to the second artificial rockwork panel 14, 162. The hog rings 180 may include C and/or D shaped fasteners and may be assembled using suitable tools (e.g., pliers).

In some embodiments, one or more of the individual artificial rockwork panels 14 may be removed and/or replaced. The artificial rockwork system 12 provides modularity in assembly of the themed structures. One or more of the mesh coupling 166 may be disassembled. In other embodiments, the coupling may be achieved by adhering the overlapping portions of the mesh layers 50 to one another. In some embodiments, the first artificial rockwork panel 14, 160 is positioned vertically adjacent to the second artificial rockwork panel 14, 162 including a space between the first artificial rockwork panel 14, 160 and the second artificial rockwork panel 14, 162 to accommodate the use of suitable tools to couple the hog rings 180. The seam 170 formed after application of the grout solution 168 can be disassembled to allow for removal of one or more of the individual artificial rockwork panels in particular cases (e.g., cases of damage, cases of change of themed structure, cases of change in the design map).

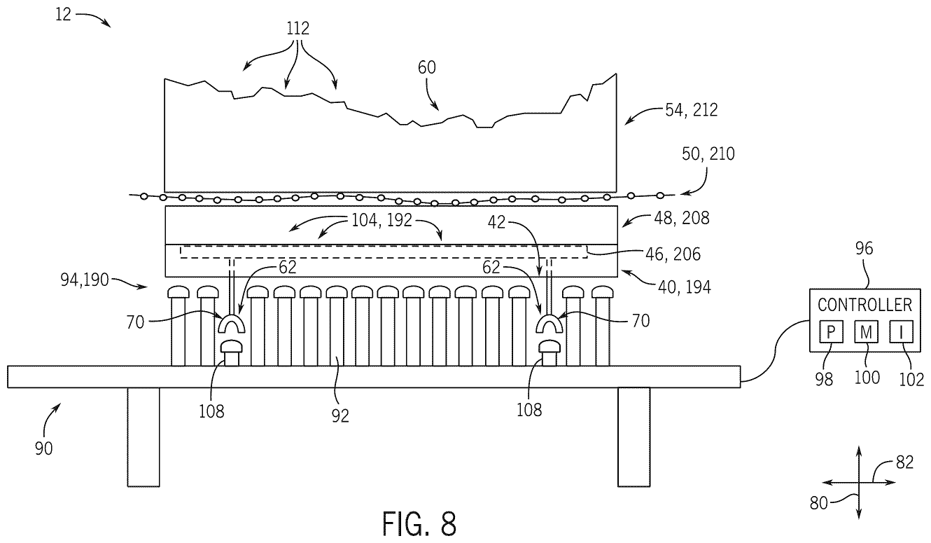

FIG. 8 is a schematic illustration of an embodiment of the artificial rockwork system 12 including the individual artificial rockwork panel 14 and the dynamic molding bed 90. To aid the discussion, a set of axes will be referenced. For example, a longitudinal axis 80 may run from top to bottom of the individual artificial rockwork panel 14, and a latitudinal axis 82 may run along the dynamic molding bed 90. The dynamic molding bed 90 may include the pins 92 (e.g., a plurality of pins) that support the formation of the individual artificial rockwork panel 14. The dynamic molding bed 90 allows for the formation of the first layer 40 of build material through dynamic control of the pins 92 to form a molding surface 94 to support a planar configuration of the first surface 42 of the first layer 40 of build material. In some embodiments, the dynamic molding bed 90 may be controlled by a controller 96 that includes the processor 98, the memory 100 and the instructions 102, as similarly described in FIG. 3.

In some embodiments, the individual artificial rockwork panel 14 is formed in whole or in part on the dynamic molding bed 90. The first layer 40, 194 of build material may be disposed on the dynamic molding bed 90 and takes on a configuration (e.g., a planar configuration, the non-planar configuration) of the plurality of pins 92. For example, the pins 92 support the first layer 40,194 of build material and generate the molding surface 94, 190 (e.g., smooth surface) on the first surface 42 of the first layer 40, 194. The level of detail 104, 192 of the first layer 40, 194 may be designed to generate the planar configuration enabling the formation of the second layer 48, 406 in the planar configuration. The reinforcement structures 46, 206 and the mesh layer 50, 210 of the present embodiment may take on the planar configuration. The exterior layer 54, 212 may be formed in the non-planar configuration. Further, the level of detail 112 of the exterior layer 54, 212 may form the rock surface (e.g., jagged surface) used externally as part of the themed environment.

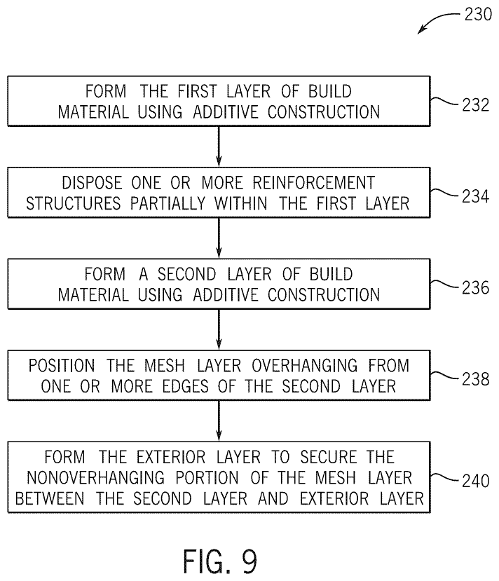

FIG. 9 is a flow chart of a method 230 of forming the individual artificial rockwork panel 14. The method 230 may include at block 232 forming the first layer 40 of build material using additive construction. In some instances, the first layer 40 is formed on the surface of the dynamic molding bed 90. In embodiments, the first layer 40 is formed on an alternative surface (e.g., mold, static mold bed, etc.). The first layer 40 of build material may take on the planar configuration or the non-planar configuration. At block 234 of the method 230 the reinforcement structures 46 may be disposed at least partially within the first layer 40 of build material. At block 236, the second layer 48 may be formed using additive construction. Further, at block 238, the mesh layer 50 may be positioned to overhang the one or more edges 126 of the second layer 48. At block 240, the exterior layer 54 may be formed over the mesh layer 50 to secure the nonoverhanging portion of the mesh layer 50 between the second layer 48 and the exterior layer 54 to form the individual artificial rockwork panel 14.

While only certain features of the disclosed technology have been illustrated and described herein, many modifications and changes will occur to those skilled in the art. It is, therefore, to be understood that the appended claims are intended to cover all such modifications and changes as fall within the true spirit of the disclosure. Furthermore, although the steps of the disclosed flowchart/s are shown in a given order, in certain embodiments, the depicted steps may be reordered, altered, deleted, and/or occur simultaneously.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. An artificial rockwork system, comprising:
a support structure; and
a plurality of artificial rockwork panels, an individual artificial rockwork panel of the plurality of artificial rockwork panels comprising:
a first layer;
one or more reinforcement structures disposed partially within the first layer and comprising one or more couplings positioned on a first end of the one or more reinforcement structures, wherein the one or more couplings are configured to couple to the support structure;
a second layer disposed over at least a portion of a second surface of the first layer to secure the one or more reinforcement structures within the individual artificial rockwork panel;
a mesh layer, wherein the mesh layer overhangs one or more edges of the second layer; and
an exterior layer disposed over the mesh layer to embed at least a portion of the mesh layer within the individual artificial rockwork panel.

2. The artificial rockwork system of claim 1, wherein a coupling of the one or more couplings comprises a hook or a clip.

3. The artificial rockwork system of claim 2, wherein the one or more reinforcement structures are formed from a different material than one or both of the first layer or the second layer.

4. The artificial rockwork system of claim 1, wherein the support structure comprises a primary support structure and a secondary support structure comprising one or more hanging rails coupled to the primary support structure.

5. The artificial rockwork system of claim 4, wherein a first rail of the secondary support structure includes a passage in which a hook of the one or more reinforcement structures is coupled.

6. The artificial rockwork system of claim 1, wherein the individual artificial rockwork panel, when coupled to the support structure via the one or more reinforcement structures, is fixed in position vertically and horizontally.

7. The artificial rockwork system of claim 1, wherein the individual artificial rockwork panel comprises one or more intervening layers between at least the mesh layer and the second layer or the mesh layer and the exterior layer.

8. The artificial rockwork system of claim 1, wherein the individual artificial rockwork panel of the plurality of artificial rockwork panels is coupled to one or more adjacent rockwork panels of the plurality of artificial rockwork panels via respective overhanging mesh layers.

9. The artificial rockwork system of claim 8, comprising a plurality of hog rings coupling an overhanging portion of the mesh layer of the individual artificial rockwork panel to overhanging portions of mesh layers of the one or more adjacent rockwork panels of the plurality of artificial rockwork panels.

10. An additive construction method for manufacturing an artificial rockwork panel, the method comprising:
forming a first layer of build material;
disposing one or more reinforcement structures partially within the first layer such that one or more couplings are positioned on a first end of the one or more reinforcement structures;
forming a second layer of build material over a portion of the one or more reinforcement structures and over a second surface of the first layer to secure the portion of the one or more reinforcement structures between the first layer and the second layer;
positioning a mesh layer on the second layer, wherein the mesh layer is configured to overhang at least one edge of the second layer; and
forming an exterior layer to secure a nonoverhanging portion of the mesh layer between the second layer and the exterior layer.

11. The method of claim 10, comprising:
forming the first layer of build material on a dynamic molding bed, wherein the dynamic molding bed comprises a plurality of pins configured to support the first layer of build material, and wherein the dynamic molding bed is configured to generate topographical features on the first surface in a non-planar configuration.

12. The method of claim 11, comprising:
independently controlling a vertical position of one or more pins of the plurality of pins, wherein the vertical position of the one or more pins permits the one or more reinforcement structures positioned beyond the first surface to occupy a space within the dynamic molding bed.

13. The method of claim 10, comprising:
forming a first portion of the exterior layer using the build material; and
forming a second portion of the exterior layer using a different material.

14. The method of claim 10, wherein the first end of the one or more reinforcement structures form a contiguous connection between the one or more reinforcement structures and an external support structure at one or more predefined locations corresponding to one or more coupling locations.

15. The method of claim 14, wherein the first surface is non-planar, and wherein the predefined locations are positioned to align with an imaginary plane of the one or more coupling locations.

16. The method of claim 14, comprising forming one or more intervening layers between at least the mesh layer and the second layer or the mesh layer and the exterior layer.

17. An individual artificial rockwork panel of a plurality of artificial rockwork panels comprising:
a first layer;
one or more reinforcement structures disposed partially within the first layer and comprising one or more couplings positioned on a first end of the one or more reinforcement structures, wherein the one or more couplings are configured to couple to a secondary support structure;
a second layer disposed over at least a portion of a second surface of the first layer to secure the one or more reinforcement structures within the individual artificial rockwork panel;
a mesh layer, wherein the mesh layer overhangs one or more edges of the second layer; and
an exterior layer disposed over the mesh layer to embed at least a portion of the mesh layer within the individual artificial rockwork panel.

18. The individual artificial rockwork panel of claim 17, wherein the mesh layer is non-directional.

19. The individual artificial rockwork panel of claim 17, wherein the first layer has a first predetermined side length and a second predetermined side length that are equal.

20. The individual artificial rockwork panel of claim 17. wherein a first portion of the exterior layer is planar and wherein a second portion of the exterior layer is non-planar.
